(19) United States
(12) Patent Application Publication
(10) Pub. No.: US 2026/0277961 A1
(43) Pub. Date: Sep. 17, 2026

(54) CONTENT PROCESSING METHOD AND APPARATUS, COMPUTER DEVICE, STORAGE MEDIUM, AND PROGRAM PRODUCT

(71) Applicant: Tencent Technology (Shenzhen) Company Limited, Shenzhen (CN)

(72) Inventors: Yicheng ZHENG, Shenzhen (CN); Chaohui TIAN, Shenzhen (CN); Jianying XIE, Shenzhen (CN); Haokun HU, Shenzhen (CN); Hengjie CAI, Shenzhen (CN); Youli YUAN, Shenzhen (CN); Hao ZHOU, Shenzhen (CN); Bin WANG, Shenzhen (CN); Xin LU, Shenzhen (CN); Jinhao LIU, Shenzhen (CN); Ye SUN, Shenzhen (CN); Yan LUO, Shenzhen (CN); Yangyin XU, Shenzhen (CN); Yuan WANG, Shenzhen (CN); Chengduo ZHAO, Shenzhen (CN); Fandong MENG, Shenzhen (CN); Ze ZENG, Shenzhen (CN); Haibo YAO, Shenzhen (CN); Lan JIANG, Shenzhen (CN); Zishan CHEN, Shenzhen (CN)

(73) Assignee: Tencent Technology (Shenzhen) Company Limited, Shenzhen (CN)

(21) Appl. No.: 19/680,440

(22) Filed: May 18, 2026

Related U.S. Application Data
(63) Continuation of application No. PCT/CN2025/090392, filed on Apr. 22, 2025.

(30) Foreign Application Priority Data
Jun. 21, 2024 (CN) 202410813182.8

(51) Int. Cl. G06F 16/3329; G06F 16/334

(52) U.S. Cl. CPC G06F 16/33295; G06F 16/334

(57) ABSTRACT

A content processing method including displaying a service interface of a first client, receiving a content input operation on the service interface, displaying an input method panel based on a query sign input by the content input operation, and displaying, in the input method panel, a first query result corresponding to content input by the content input operation.

### CROSS-REFERENCE TO RELATED APPLICATIONS

This application is a continuation application of International Application No. PCT/CN2025/090392 filed on Apr. 22, 2025, which claims priority to Chinese Patent Application No. 202410813182.8, filed with the China National Intellectual Property Administration on Jun. 21, 2024, the disclosures of each being incorporated by reference herein in their entireties.

### FIELD

The disclosure relates to the field of computer technologies, and specifically, to a content processing method, a content processing apparatus, a computer device, a computer-readable storage medium, and a computer program product.

### BACKGROUND

In the related art, content input is widely applied to various service scenarios. For example, content input needs to be performed in an instant messaging scenario. For another example, content input needs to be performed in a document editing scenario. In a content input process, there is a requirement for querying input content. Based on the requirement, there is a need to increase the speed of obtaining a query result corresponding to the input content in the content input process.

### SUMMARY

Some embodiments provide a content processing method and apparatus, a computer device, a storage medium, and a program product, to rapidly obtain a query result corresponding to input content in a content input process.

One or more embodiments provide a content processing method includes: displaying a service interface of a first client; receiving a content input operation on the service interface; displaying an input method panel based on a query sign input by the content input operation; and displaying, in the input method panel, a first query result corresponding to content input by the content input operation.

One more embodiments provide an information processing apparatus including: at least one memory configured to store program code; and at least one processor configured to read the program code and operate as instructed by the program code, the program code comprising: display code configured to cause at least one of the at least one processor to: display a service interface of a first client; receive a content input operation on the service interface; display an input method panel based on a query sign input by the content input operation; and display, in the input method panel, a first query result corresponding to content input by the content input operation.

One or more embodiments provide a non-transitory computer-readable storage medium, storing computer code which, when executed by at least one processor, causes the at least one processor to at least: display a service interface of a first client; receive a content input operation on the service interface; display an input method panel based on a query sign input by the content input operation; and display, in the input method panel, a first query result corresponding to content input by the content input operation.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic architectural diagram of a content processing system according to one or more embodiments.

FIG. 2 is a schematic flowchart of a content processing method according to one or more embodiments.

FIG. 3A is a schematic diagram of receiving a content input operation on a service interface according to one or more embodiments.

FIG. 3B is a schematic diagram of receiving a content input operation on a service interface according to one or more embodiments.

FIG. 4A is a schematic diagram of an interface of a relationship between an input position of a query sign and queried content according to one or more embodiments.

FIG. 4B is a schematic diagram of another interface of a relationship between an input position of a query sign and queried content according to one or more embodiments.

FIG. 4C is a schematic diagram of still another interface of a relationship between an input position of a query sign and queried content according to one or more embodiments.

FIG. 5 is a schematic diagram of yet another interface of a relationship between an input position of a query sign and queried content according to one or more embodiments.

FIG. 6 is a schematic diagram of a query result of an explicit intention according to one or more embodiments.

FIG. 7 is a schematic diagram of a query result of a general intention according to one or more embodiments.

FIG. 8 is a schematic diagram of an interface of continued exploration of reference information according to one or more embodiments.

FIG. 9 is a schematic diagram of an interface of continued exploration of relevant query content according to one or more embodiments.

FIG. 10 is a schematic diagram of an interface of querying an image according to one or more embodiments.

FIG. 11 is a schematic diagram of a query failure result according to one or more embodiments.

FIG. 12 is a schematic diagram of an interface of querying new content in an input method panel according to one or more embodiments.

FIG. 13 is a schematic flowchart of another content processing method according to one or more embodiments.

FIG. 14A is a schematic diagram of an interface of an activation manner of a query function according to one or more embodiments.

FIG. 14B is a schematic diagram of an interface of another activation manner of a query function according to one or more embodiments.

FIG. 15 is a schematic diagram of an interface of streaming output of a query result according to one or more embodiments.

FIG. 16A is a schematic diagram of an interface of sharing a query result in a text form according to one or more embodiments.

FIG. 16B is a schematic diagram of an interface of sharing a query result in a picture form according to one or more embodiments.

FIG. 16C is a schematic diagram of an interface of sharing a query result in a speech form according to one or more embodiments.

FIG. 16D is a schematic diagram of an interface of sharing a query result in a link form according to one or more embodiments.

FIG. 16E is a schematic diagram of an interface of selecting a sharing type of a query result according to one or more embodiments.

FIG. 17 is a schematic diagram of an interface of selecting a partial query result for sharing according to one or more embodiments.

FIG. 18 is a schematic flowchart of interaction between a terminal and a backend server according to one or more embodiments.

FIG. 19 is a schematic flowchart of still another content processing method according to one or more embodiments.

FIG. 20 is a schematic diagram of a generation process of a query result according to one or more embodiments.

FIG. 21 is a schematic structural diagram of a content processing apparatus according to one or more embodiments.

FIG. 22 is a schematic structural diagram of a computer device according to one or more embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

One or more embodiments relate to an input method. The input method is software configured to input content. One or more embodiments provides a content processing method. The content processing method provides an innovative input method. Through the input method, in a content input process, a query result corresponding to input content may be quickly obtained by inputting a query sign. More specifically, through the input method, in the content input process, an artificial intelligence (AI) large model is quickly activated by inputting the query sign, and the query result corresponding to the input content is obtained and presented by invoking the AI large model. A query operation triggered by inputting the query sign may enable a content inputter to use an extremely simplified AI large model activation manner, thereby conveniently resolving a current query requirement.

The AI large model is a machine learning model with extremely large-scale (usually more than a billion) parameters and powerful computing resources, and can process massive data and complete various complex tasks, such as natural language processing and image recognition processing.

In one or more embodiments, a service interface of a first client may be displayed, and a content input operation on the service interface may be received. It can be learned that in some embodiments, human-computer interaction can be implemented by using the service interface, to visually implement the content input operation and present corresponding operation feedback on the service interface. In response to a query sign inputted by the content input operation, an input method panel may be displayed, and a first query result corresponding to content inputted by the content input operation may be displayed in the input method panel. It can be learned that, in some embodiments, the input method panel can be quickly activated by using the query sign, and the query result corresponding to the input content is displayed in the input method panel. In other words, querying for the input content can be triggered by inputting the query sign, and the query result corresponding to the input content is obtained and outputted. The query sign is inputted easily and quickly. Therefore, in some embodiments, the query result corresponding to the input content can be quickly obtained in a content input process by inputting the query sign, thereby improving query efficiency and convenience

In one or more embodiments, the content processing method may be performed by a computer device, and the input method provided in one or more embodiments is run on the computer device. The computer device may be, for example, a terminal of a content inputter, and the input method provided in one or more embodiments may be run on the terminal of the content inputter. In some embodiments, for example, the computer device may be a content processing system including a terminal and a backend server. A front end of the input method provided in one or more embodiments may be run on the terminal, and the backend server may be a backend of the input method provided in one or more embodiments, and is configured to provide services to the front end.

In some embodiments, the computer device may be the terminal of the content inputter. The AI large model may be deployed in the terminal of the content inputter. In the content input process, by using the input method run on the terminal, the content inputter can quickly activate, by inputting the query sign, the AI large model deployed in the terminal, and invoke the AI large model to obtain and present the query result corresponding to the input content.

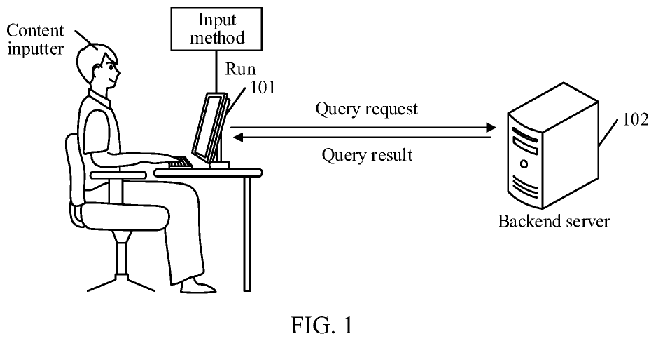

In some embodiments, the computer device may be a content processing system including the terminal of the content inputter and the backend server, and the AI large model may be deployed in the backend server of the input method. As shown in FIG. 1, the content processing system may include a terminal 101 used by a content inputter and a backend server 102 of an input method. In the content processing system, in a process in which the content inputter inputs content by using the input method run on the terminal 101, if the terminal 101 detects that the content inputter inputs a query sign by using the input method run on the terminal, the terminal 101 may send a query request to the backend server 102. The backend server 102 may invoke the deployed AI large model to obtain a query result corresponding to the input content, and send the query result corresponding to the input content to the terminal 101. The terminal 101 may present the query result corresponding to the input content to the content inputter.

The terminal 101 involved in one or more embodiments may be a smartphone, a tablet computer, a notebook computer, a desktop computer, an intelligent voice interaction device, a smart watch, an in-vehicle terminal, a smart home appliance, an aircraft, and the like, but is not limited thereto. In other words, the input method provided in one or more embodiments is applicable to a personal computer (PC) end (for example, a notebook computer and a desktop computer), or is applicable to a mobile end (for example, a smartphone, a tablet computer, a smart watch, and an in-vehicle terminal).

The backend server 102 involved in one or more embodiments may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, as described herein.

The content processing system described in one or more embodiments is intended to describe the technical solutions more clearly, and does not constitute a limitation on the technical solutions. A person of ordinary skill in the art may learn that, with evolution of a system architecture and emergence of new service scenarios, the technical solutions provided in one or more embodiments are also applicable to similar technical problems.

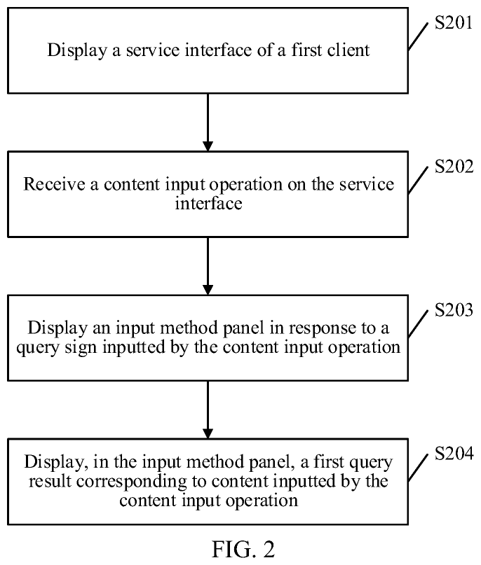

One or more embodiments provides a content processing method. Content described in the content processing method includes: content included in a query result, continued exploration of the query result, and different situations of queried content when a query sign is inputted to different positions of input content. As shown in FIG. 2, the content processing method may include, but is not limited to, the following operation S201 to operation S204.

S201: Display a service interface of a first client.

The first client may be a client having a content input requirement, for example, a document editing client or an instant messaging client. The input method used by the first client is an input method provided in one or more embodiments. A type of the client is not limited herein, and the client may include, but is not limited to, any one of the following: an application, a mini program, software, a World Wide Web (web) application, and the like. The service interface may be an interface having a content input requirement in the first client. For example, the service interface may be a document editing interface in a document editing client. There is a content input requirement on the document editing interface, and input content may be used as document content. For another example, the service interface may be an instant messaging interface in an instant messaging client. There is a content input requirement on the instant messaging interface, and input content may be used as instant messaging message content.

S202: Receive a content input operation on the service interface.

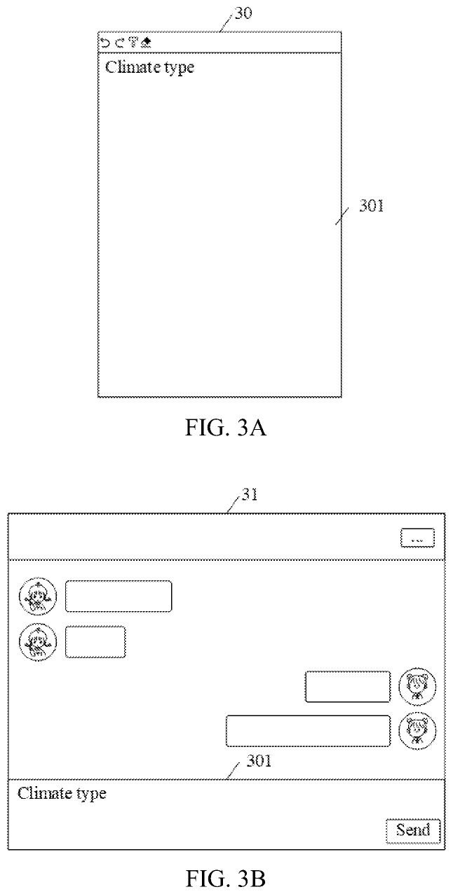

The receiving a content input operation on the service interface may include: receiving a content input operation in an input box on the service interface. For example, in FIG. 3A, a text editing interface 30 may include an input box 301. A content input operation in the input box 301 in the text editing interface 30 may be received, and input content is “Climate type”. For another example, in FIG. 3B, an instant messaging interface 31 may include an input box 301. A content input operation in the input box 301 in the instant messaging interface 31 may be received, and input content is “Climate type”.

S203: Display an input method panel in response to a query sign inputted by the content input operation.

S204: Display, in the input method panel, a first query result corresponding to content inputted by the content input operation.

In operation S203 and operation S204, in response to the query sign inputted by the content input operation, the input method panel is displayed, and a first query result corresponding to the content inputted by the content input operation may be displayed in the input method panel. Specifically, that in response to the query sign inputted by the content input operation, the input method panel is displayed may include: displaying the input method panel in response to the query sign inputted, after target content is inputted, by the content input operation. The first client uses the input method provided in one or more embodiments, and the input method panel is an interface provided by the input method used by the first client. The query sign is a sign that is less frequently used in a content input scenario. In one or more embodiments, an example in which the query sign is “=” is used for description, and “=” is less frequently used in the content input scenario, and a scenario in which a content inputter inputs “=” is usually a calculation scenario or a code editing scenario. Therefore, such an invoking manner achieves a good balance between “useful” and “disturbing”. In addition to “=”, the query sign may be another sign that is less frequently used in the content input scenario. This is not limited herein.

When the query sign is inputted to different positions of the target content, queried content may be different. In some embodiments, when the query sign is inputted at any position of the target content, the queried content is the target content. In this implementation, the any position may be, for example, a tail of the target content, a beginning of the target content, or in the target content. Based on this, the displaying, in the input method panel, a first query result corresponding to content inputted by the content input operation may include: displaying the first query result corresponding to the target content in the input method panel.

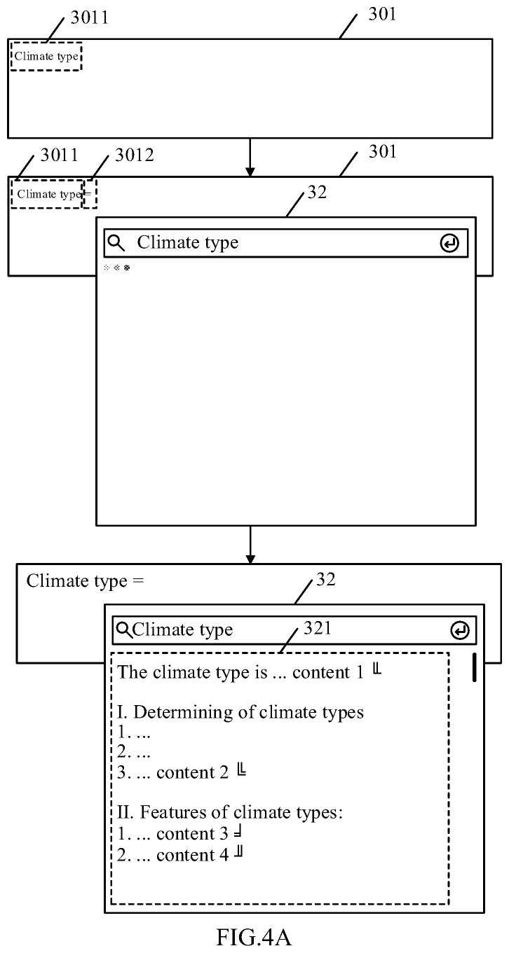

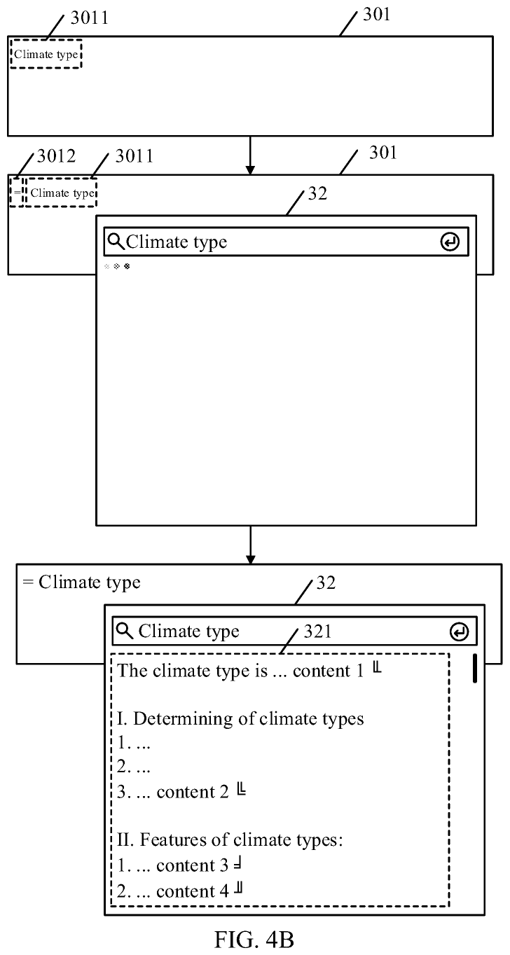

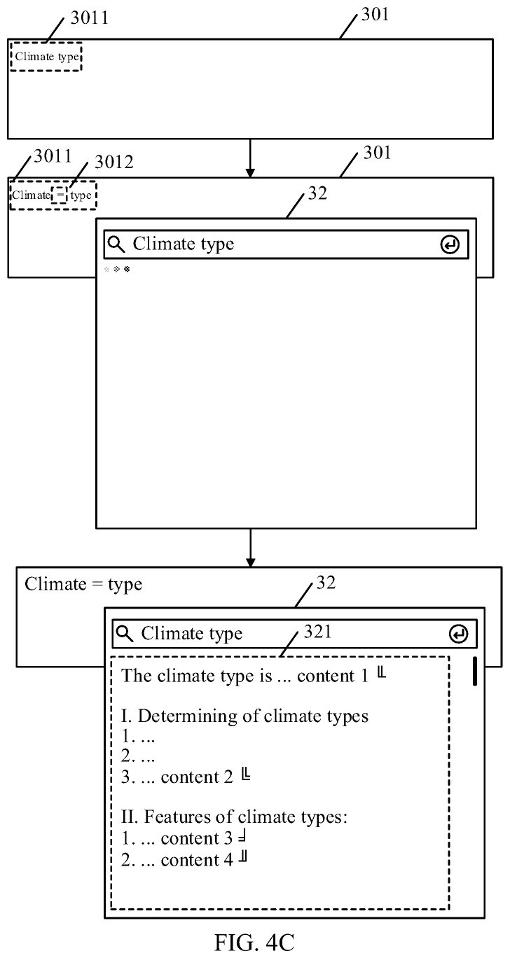

For example, in FIG. 4A, target content 3011 inputted by the content input operation in the input box 301 is “Climate type”. In response to a query sign 3012 inputted at a tail of the target content 3011, an input method panel 32 may be displayed, and a first query result 321 corresponding to the target content 3011 may be displayed in the input method panel 32. For another example, in FIG. 4B, the target content 3011 inputted by the content input operation in the input box 301 is “Climate type”. In response to the query sign 3012 inputted at a beginning of the target content 3011, the input method panel 32 may be displayed, and the first query result 321 corresponding to the target content 3011 may be displayed in the input method panel 32. For still another example, in FIG. 4C, the target content 3011 inputted by the content input operation in the input box 301 is “Climate type”. In response to the query sign 3012 inputted in the target content 3011 (for example, in FIG. 4C, the query sign 3012 is inputted between “Climate” and “type”), the input method panel 32 may be displayed, and the first query result 321 corresponding to the target content 3011 may be displayed in the input method panel 32.

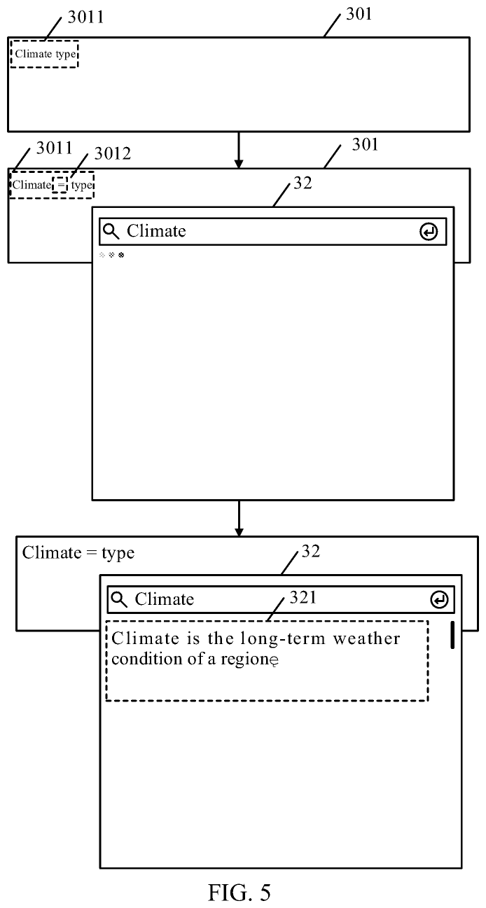

In some embodiments, when the query sign is located at the beginning or the tail of the target content, the first query result corresponding to the target content may be displayed in the input method panel, as shown in FIG. 4A and FIG. 4B. A first query result corresponding to first content may be displayed in the input method panel when the query sign is located in the target content. The first content is content located before the query sign in the target content. For example, in FIG. 5, the target content 3011 inputted by the content input operation in the input box 301 is “Climate type”. In response to the query sign 3012 inputted in the target content 3011 (for example, in FIG. 5, the query sign 3012 is inputted between “Climate” and “type”), the input method panel 32 may be displayed, and a first query result 321 corresponding to “Climate” before the query sign 3012 may be displayed in the input method panel 32.

The first query result may include at least one of the following: answer content corresponding to the content inputted by the content input operation, reference information of the answer content, or query content semantically relevant to the content inputted by the content input operation. The answer content is content that uses content inputted by the content input operation as a question and answers the question. The reference information of the answer content is introduction information of reference content referenced by the answer content. For example, the reference content of the answer content may be a book, a network diary (such as a blog, a post, and an article), and the like. The introduction information of the reference content is information that introduces the reference content. For example, when the reference content is a book, the introduction information of the reference content may be a book name, a book author, a referenced chapter, and the like. For another example, when the reference content is a network diary, the introduction information of the reference content may be a diary title, a diary author, and the like. The query content semantically relevant to the content inputted by the content input operation may be understood as content that performs semantic expansion on the content inputted by the content input operation. That is, semantic relevance means that semantics of the query content include the semantics of the input content, and expansion is performed based on the semantics of the input content. For example, the input content is “Climate type”, and the query content is “What are the differences between various climate types”.

In some embodiments, a category of result content included in the query result is relevant to a query intention of the content inputted by the content input operation. Specifically, a plurality of preset intentions are set in an input method to which an input method panel belongs. The plurality of preset intentions may include an explicit intention and a general intention, the explicit intention is an intention for obtaining a query result of a specific type, and the general intention is an intention for obtaining a general query result. When the query intention of the content inputted by the content input operation is the explicit intention, the first query result may include the answer content corresponding to the content inputted by the content input operation; or when the query intention of the content inputted by the content input operation is the general intention, the first query result may include the answer content corresponding to the content inputted by the content input operation, the reference information of the answer content, and the query content semantically relevant to the content inputted by the content input operation.

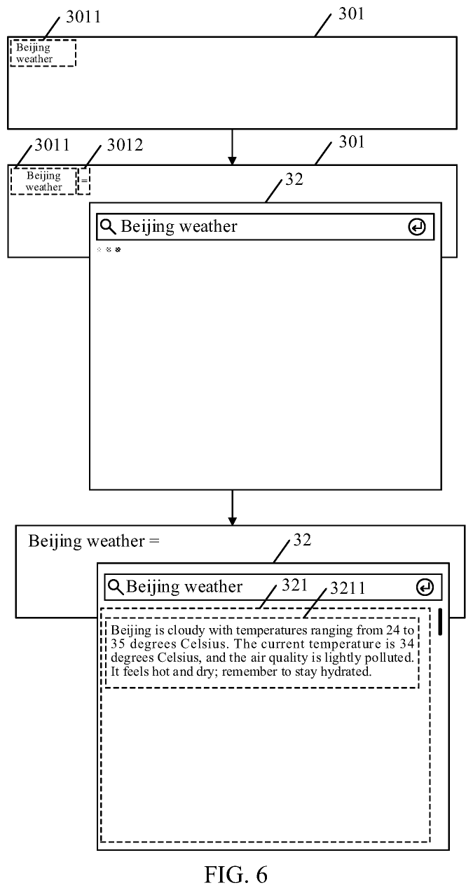

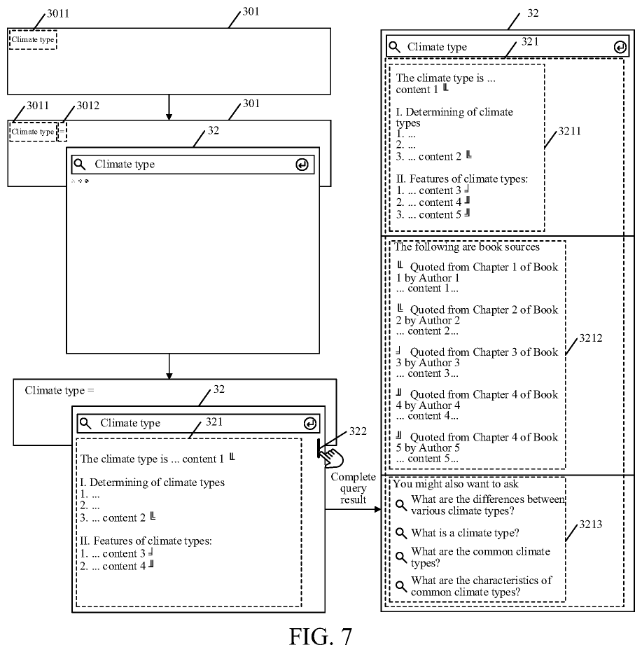

For example, as shown in FIG. 6, the target content 3011 inputted by the content input operation in the input box 301 is “Beijing weather”. The query intention of the content is to obtain a query result of a weather type. The query intention of the content is the explicit intention. In response to the query sign 3012 inputted at a tail of the target content 3011, the input method panel 32 may be displayed, and the first query result 321 displayed in the input method panel 32 includes answer content 3211. As shown in FIG. 7, the target content 3011 inputted by the content input operation in the input box 301 is “Climate type”, the query intention of the content is relatively general, and the query intention of the content is the general intention. The input method panel 32 may be displayed in response to the query sign 3012 inputted at a tail of the target content 3011. The first query result 321 displayed in the input method panel 32 may include the answer content 3211, reference information 3212 of the answer content 3211, and query content 3213 semantically relevant to the target content 3011.

In this manner, when the query intention of the content inputted by the content input operation is to obtain specific information, for example, weather, the query result includes only the answer content, and the answer content is sufficient to provide specific information that the content inputter expects. In this way, the query result that the content inputter expects may be quickly provided to the content inputter. If the query result further includes the reference information and the query content, the query result is relatively redundant, and the information may not be information that the content inputter expects. Instead, accuracy and efficiency of obtaining the query result by the content inputter are reduced. When the query intention of the content inputted by the content input operation is the general intention, the query result may include the answer content, the reference information of the answer content, and the relevant query content. The reference information of the answer content is more comprehensive introduction information of a book and the like with a relatively high confidence. In this way, a more comprehensive query result with a higher confidence may be provided for the content inputter, thereby improving accuracy of the query result.

Limited by a size of the input method panel, the query result may not be completely displayed in the input method panel. In this case, a complete query result may be viewed in a manner such as sliding by finger, rolling a mouse wheel, or sliding a scroll bar in the input method panel (for example, the input method panel 32 shown in FIG. 7 may include a scroll bar 322). FIG. 7 shows the complete query result.

Further, the query result may support continued exploration, and result content supporting continued exploration in the query result may include the reference information and the relevant query content. Specific descriptions are as follows.

### (1) Continued Exploration of the Reference Information:

In response to a trigger operation for the reference information of the answer content, an original text of the reference content may be displayed. Specifically, the answer content may include one or more pieces of subcontent, a reference marker is added to each piece of target subcontent including reference content in the answer content, the reference information may include reference information of each piece of target subcontent, and the reference information of each piece of target subcontent is introduction information of reference content referenced by the target subcontent. A reference marker of the reference information of each piece of target subcontent corresponds to the reference marker added to the target subcontent. An original text of reference content referenced by the any piece of target subcontent may be displayed in response to a trigger operation for reference information of any piece of target subcontent.

In addition, a source of the reference content of the answer content may be a second client. The second client and the first client are different clients. The second client is not a client provided by the input method. In response to the trigger operation for the reference information, the original text of the reference content may be displayed in the second client. It can be seen that knowledge sharing between different clients is implemented by using the input method, and the input method can integrate knowledge in different clients to generate the answer content, thereby improving accuracy of answer information.

For example, as shown in FIG. 7, the first query result 321 corresponding to the target content 3011 displayed in the input method panel 32 may include the answer content 3211, the reference information 3212 of the answer content 3211, and the query content 3213 semantically relevant to the target content 3011. Five pieces of target subcontent in the answer content 3211 include reference content, and reference markers “\textcircled{1} to \textcircled{5}” are sequentially added to the five pieces of target subcontent according to an appearance order. The reference information includes reference information of the five pieces of target subcontent, and reference markers of the reference information of the target subcontent correspond to the added reference markers of the target subcontent. For example, the reference marker “\textcircled{1}” of “content 1” corresponds to a reference marker “\textcircled{1}” of reference information of “content 1”.

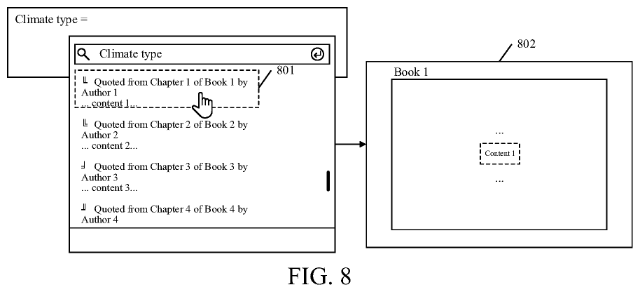

As shown in FIG. 8, the second client may be, for example, a reading client. In response to a trigger operation for reference information 801 (for example, content in FIG. 8 is reference information “Chapter 1 of book 1 by author 1”) corresponding to the reference marker “\textcircled{1}”, a referenced original text corresponding to subcontent (for example, “content 1” in FIG. 8) marked by the reference marker “\textcircled{1}” may be displayed in an original detail page 802 of the second client. In addition, the subcontent marked by the reference marker “\textcircled{1}” may be highlighted in the referenced original text (for example, “content 1” in FIG. 8 is highlighted by adding a dashed box).

In this manner, the content inputter may continue to explore the reference information and view the referenced original text. Using a book as an example, the query result shows book content referenced by the answer content, and may be further referred to by the content inputter, or the original text of the referenced book may be further viewed. In this way, the content inputter can quickly obtain more information relevant to the content inputted by the content input operation.

### (2) Continued Exploration of the Relevant Query Content:

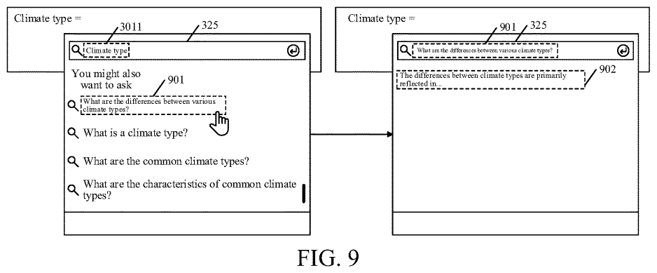

A second query result corresponding to the query content may be displayed in the input method panel in response to a query operation for the query content. As shown in FIG. 9, the inputted target content 3011 is “Climate type”, and there are four pieces of query content in the query result corresponding to the inputted target content 3011. If the first piece of query content 901 (for example, “What are the differences between various climate types?” in FIG. 9) is triggered, a query question in a query box 325 in the input method panel 32 is replaced from the target content 3011 with the first piece of query content 901, and a second query result 902 corresponding to the first piece of query content 901 may be displayed in the input method panel 32.

In this manner, the content inputter may continue to explore the query content relevant to the input content, to explore new knowledge. In this way, the content inputter can quickly obtain more information relevant to the content inputted by the content input operation.

The trigger operation in one or more embodiments may include, but is not limited to, any one of the following: a single click/tap operation, a double click/tap operation, or a long-press operation. The being triggered in one or more embodiments may include, but is not limited to, any one of the following: being single-clicked/tapped, being double-clicked/tapped, or being long-pressed.

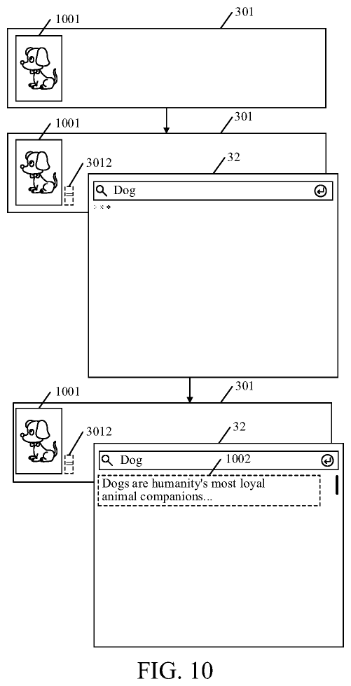

The content processing method provided in one or more embodiments is described in operation S201 to operation S204 by using an example in which the content inputted by the content input operation is text content. In some embodiments, when the content inputted by the content input operation is content of another type (for example, a picture, a speech, or a video), the content processing method provided in one or more embodiments is also applicable. As shown in FIG. 10, an example in which the content inputted in the input box 301 by the content input operation is a picture 1001 (for example, a picture including a dog) is used. In response to the query sign 3012 inputted at a tail of the picture 1001, the input method panel 32 may be displayed, and a query result 1002 corresponding to the picture 1001 (for example, a query result about the dog in FIG. 10) may be displayed in the input method panel 32. In this manner, querying different types of content can be supported, and query results corresponding to different types of content may be quickly obtained by inputting the query sign. A case in which the content inputted by the content input operation is a video and the content inputted by the content input operation is a speech is similar to the case in which the content inputted by the content input operation is a picture, and details are not described herein again.

The content processing method provided in one or more embodiments is described in operation S201 to operation S204 by using an example in which the content inputted by the content input operation is successfully queried. In some embodiments, if querying on the content inputted by the content input operation fails, a query failure prompt may be outputted to the input method panel. Specifically, after the input method panel is displayed in response to the query sign inputted by the content input operation, if the content inputted by the content input operation satisfies a query condition, displaying the first query result corresponding to the content inputted by the content input operation in the input method panel may be triggered. If the content inputted by the content input operation does not satisfy the query condition, the query failure prompt may be displayed in the input method panel. That the content inputted by the content input operation does not satisfy the query condition may include any one of the following: a quantity of times of querying in a statistical time period by the content inputter performing the content input operation exceeds a query threshold (for example, querying is triggered 20 times by inputting a query sign within one minute, which exceeds the query threshold by 15 times), the content inputter performing the content input operation is an invalid object (that is, a blacklist object), an invalid word exists in the content inputted by the content input operation, the content inputter performing the content input operation does not have query permission (for example, the content inputter performing the content input operation does not enable query permission), and the content inputted by the content input operation is content that is meaningless and cannot match the preset intention of the input method.

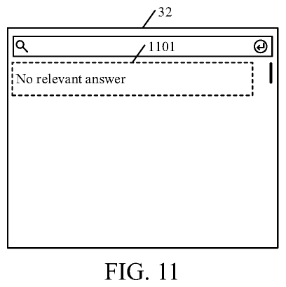

As shown in FIG. 11, when the query condition is not satisfied, a query failure prompt 1101 (for example, a prompt with “No relevant answer” in FIG. 11) may be outputted to the input method panel 32. In this manner, a query function of the input method can be controlled, to avoid a case in which query resources are wasted due to using frequent queries as entertainment, invalid content queries, invalid object queries, meaningless queries, or the like.

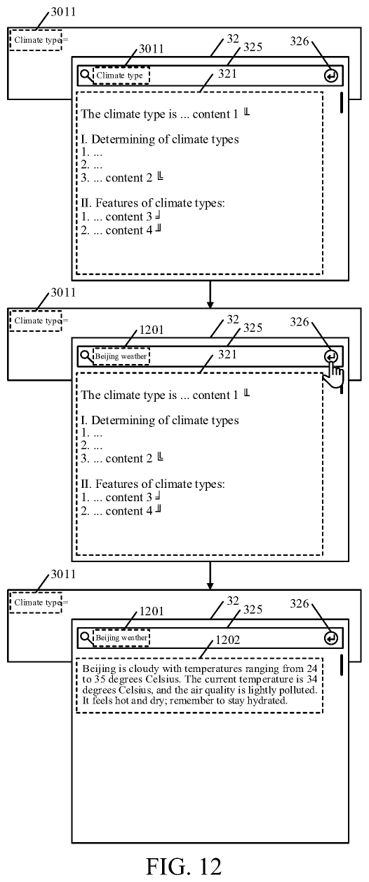

The content processing method provided in one or more embodiments may further support, after the input method panel is activated, using the input method panel as a query panel, to continue querying for new content. Specifically, as shown in FIG. 12, the first query result 321 corresponding to the inputted target content 3011 (the target content 3011 is “Climate type”) is displayed in the input method panel 32. The input method panel 32 may further include the query box 325 and a first query control 326, and the target content 3011 is displayed in the query box 325. The content inputter may delete the target content 3011 in the query box 325, re-input new content 1201 (for example, the re-inputted new content is “Beijing weather”), query for the new content 1201 by triggering the first query control 326, and display a query result 1202 corresponding to the new content 1201 in the input method panel 32. In this manner, the content inputter can perform queries a plurality of times in the content input process, and does not need to end the content input process and jump to a dedicated content query end to perform content query. In this way, efficiency of performing content query in the content input process can be improved.

In addition, in one or more embodiments, through a query triggering manner of inputting a query sign, a client having a requirement for inputting a query sign at a high frequency may further be shielded. Specifically, in response to the query sign inputted by the content input operation, if a service type of the first client is a first service type, the displaying an input method panel may be triggered. The first service type is a service type in which the query sign is inputted at a low frequency. The low frequency herein means that an accumulated quantity of times of inputting the query sign in the first client is less than or equal to a quantity threshold, and specifically means that the accumulated quantity of times of inputting the query sign in the first client is less than or equal to the quantity threshold within a preset time period before the query sign is inputted in response to the content input operation. For example, the first service type may include a document editing service, an instant messaging service, and the like. The query sign is inputted at a relatively low frequency in a service execution process of these service types. If the service type of the first client is a second service type, the input method panel is not displayed. The second service type is a service type in which the query sign is inputted at a high frequency. The high frequency herein means that an accumulated quantity of times of inputting the query sign in the first client is greater than a quantity threshold, and specifically means that the accumulated quantity of times of inputting the query sign in the first client is greater than the quantity threshold within a preset time period before the query sign is inputted in response to the content input operation. For example, the second service type may include a code editing service, a formula editing service, a calculator service, and the like. The query sign is inputted at a relatively high frequency in a service execution process of these service types. In this manner, a case in which the query function is activated by incorrectly inputting a query sign on a client having a requirement for inputting the query sign at a high frequency can be effectively avoided.

In some embodiments, different query signs may be set for a client of the first service type and a client of the second service type. A first query sign set for the client of the first service type is less frequently used in the client of the first service type, and a second query sign set for the client of the second service type is less frequently used in the client of the second service type. In this way, a query function can be quickly activated by inputting the query signs in the client of the first service type and the client of the second service type, to obtain query results.

In one or more embodiments, the query result corresponding to the input content may be obtained by inputting the query sign. The query sign is inputted easily and quickly, so that the query result corresponding to the input content can be quickly obtained in the content input process by inputting the query sign. In one or more embodiments, in the content input process, the query result corresponding to the input content is obtained by using the query sign. An advantage of such a query manner is: when the content inputter has a query requirement in the content input process, the content inputter does not need to end the content input process to jump to the dedicated content query end for querying, and can quickly and conveniently activate the query function in the content input process to obtain the query result, thereby improving query efficiency in the content input process.

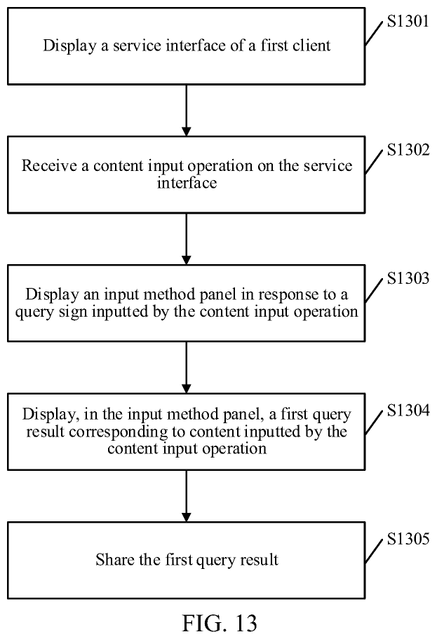

One or more embodiments provides a content processing method. Content described in the content processing method includes: sharing a query result. As shown in FIG. 13, the content processing method may include, but is not limited to, the following operation S1301 to operation S1305.

S1301: Display a service interface of a first client.

An execution process of operation S1301 in one or more embodiments is the same as the execution process of operation S201 in the embodiment shown in FIG. 2. For details, refer to the execution process of operation S201 in the embodiment shown in FIG. 2. Details are not described herein again.

S1302: Receive a content input operation on the service interface.

An execution process of operation S1301 in one or more embodiments is the same as the execution process of operation S201 in the embodiment shown in FIG. 2. For details, refer to the execution process of operation S201 in the embodiment shown in FIG. 2. Details are not described herein again.

S1303: Display an input method panel in response to a query sign inputted by the content input operation.

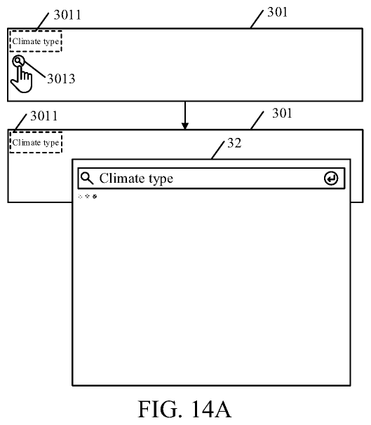

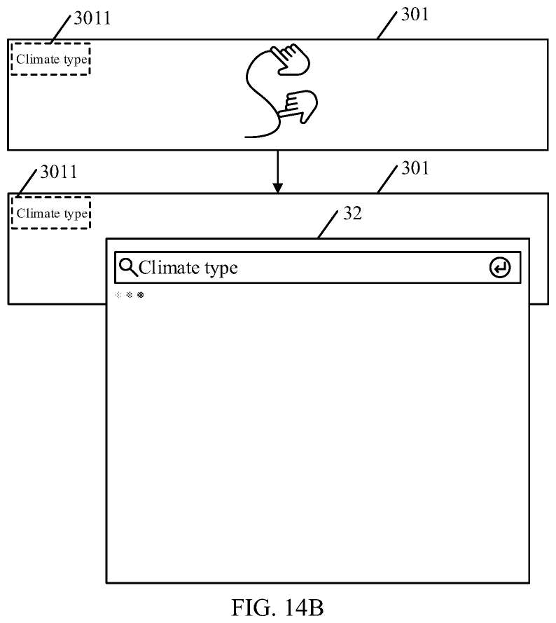

In operation S1303, the input method panel may be displayed in response to the query sign inputted by the content input operation. That is, a query function may be activated by inputting the query sign. In addition to a manner of inputting the query sign, the query function may be activated in another manner. For example, the query function may be activated in response to a trigger operation for a query control (the query control herein is a second query control). As shown in FIG. 14A, the input box 301 may include a second query control 3013. The target content 3011 inputted by the content input operation in the input box 301 is “Climate type”. The input method panel 32 may be displayed in response to the trigger operation for the second query control 3013. For another example, the query function may be activated in response to an inputted query gesture. As shown in FIG. 14B, the target content 3011 inputted by the content input operation in the input box 301 is “Climate type”, and the input method panel 32 may be displayed in response to the query gesture (for example, a gesture with a shape of “S” is inputted in FIG. 14B) inputted in the input box 301. In this manner, a plurality of different manners may be supported to activate querying for input content. The manners are convenient and quick, so that the query result corresponding to the input content may be quickly obtained in the plurality of different manners.

S1304: Display, in the input method panel, a first query result corresponding to content inputted by the content input operation.

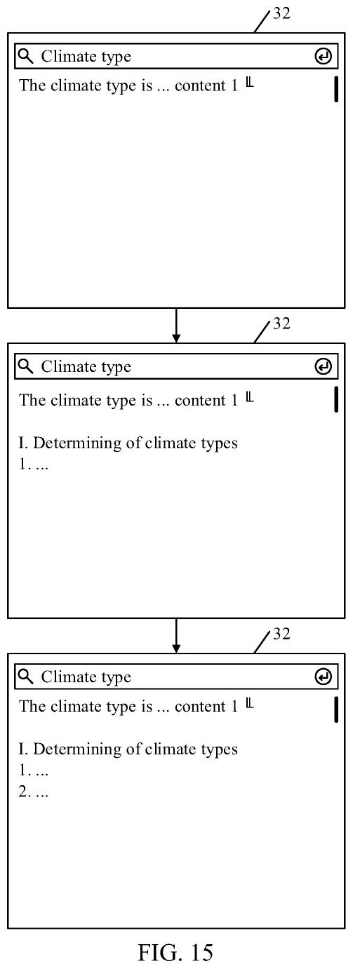

The first query result corresponding to the content inputted by the content input operation may be displayed paragraph by paragraph in the input method panel. As shown in FIG. 15, the first query result is displayed paragraph by paragraph in the input method panel 32 by using a complete paragraph as a unit. That is, one or more embodiments supports streaming output of the query result of a “whole-paragraph output” type. Compared with a word-by-word output manner mostly used, the “whole-paragraph output” manner makes the query result more readable.

A plurality of preset intentions are set for an input method to which the input method panel belongs (that is, an input method used by the first client), and the first query result is a query result under a preset intention in a highest association with a query intention of the content inputted by the content input operation. Specifically, the displaying, in an input method panel, a first query result corresponding to content inputted by the content input operation may include: displaying, in the input method panel, the query result corresponding to the content inputted by the content input operation under a first preset intention. The first preset intention is a preset intention in a highest association with the query intention of the content inputted by the content input operation among the plurality of preset intentions. The association herein means a similarity between a query intention and a preset intention. A higher similarity indicates a higher association. For example, preset intentions such as stocks, weather, exchange rate, translation, and book search (that is, searching in books) are set in the input method, and when the content inputted by the content input operation is “Beijing weather”, a query result under the “weather” intention is outputted. For another example, when the content inputted by the content input operation is “Hello in French”, a query result under the “translation” intention is outputted. For still another example, when the content inputted by the content input operation is “Climate type”, a query result under the “query book” intention is outputted. In this manner, a query result with a highest association between the preset intentions and the query intention of the input content is outputted, so that the content inputter can quickly obtain an expected query result.

S1305: Share the first query result.

In one or more embodiments, sharing of the query result may be supported, and the first query result in the input method panel may be shared. The sharing herein means using the first query result. For example, in a document editing scenario, sharing means performing document editing by using the first query result. For another example, in an instant messaging scenario, sharing means performing instant messaging by using the first query result.

The first query result may be displayed in a text form, and a manner of sharing the first query result may include any one of the following. In the first manner, the first query result may be shared in the text form. Sharing in the text form means using, in the text form, the first query result presented in the text form. In the second manner, the first query result may be shared in a picture form. Sharing in the picture form means converting the first query result presented in the text form into the picture form for use. In the third manner, the first query result may be shared in a speech form. Sharing in the speech form means converting the first query result presented in the text form into the speech form for use. In the fourth manner, the first query result may be shared in a link form. Sharing in the link form means converting the first query result presented in the text form into the link form for use.

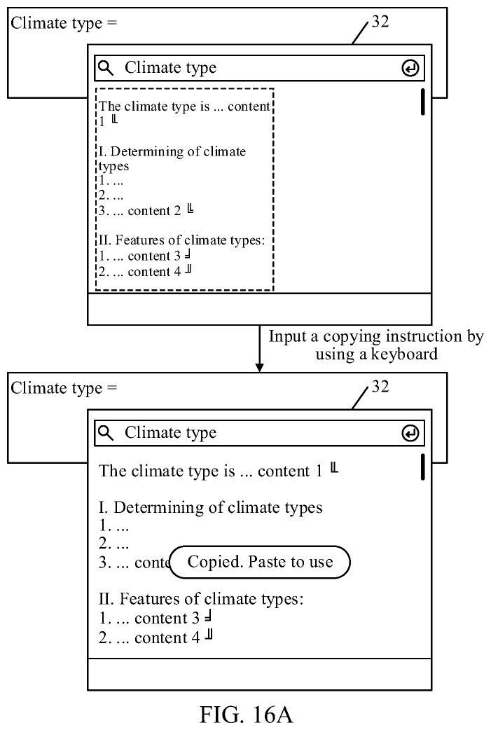

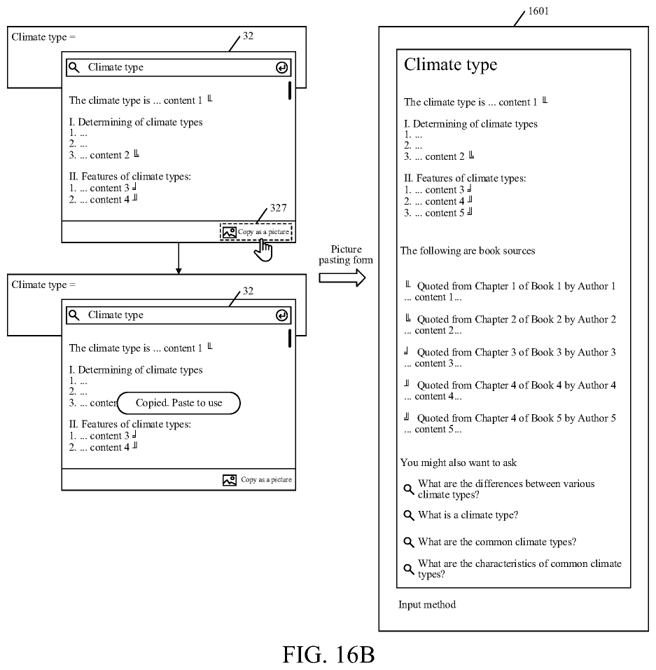

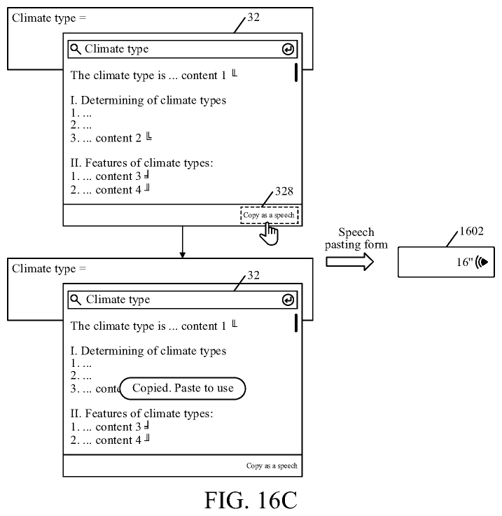

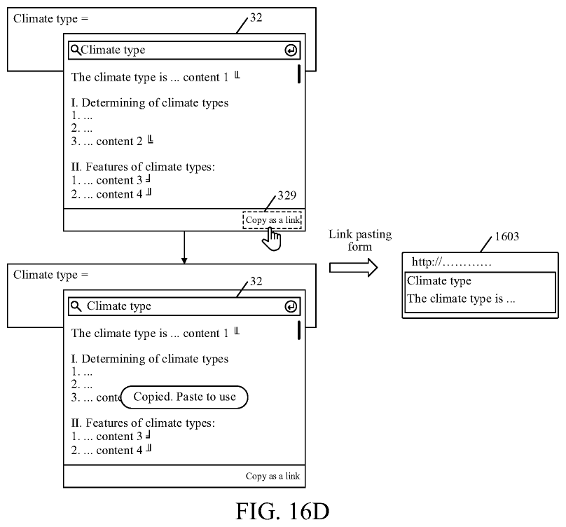

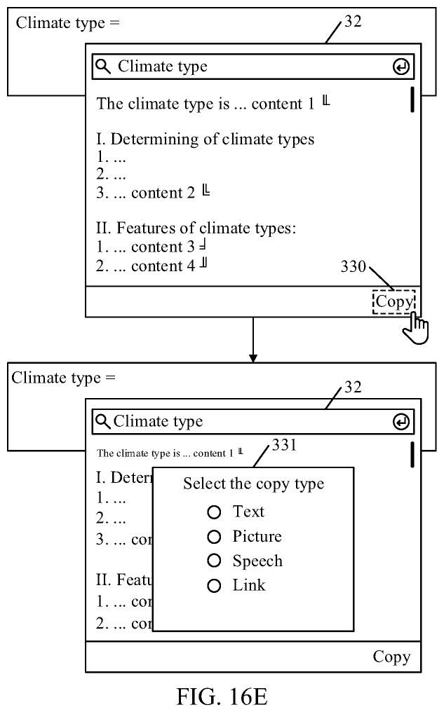

As shown in FIG. 16A, the first query result may be copied (for example, a copying instruction (for example, the copying instruction may be Ctrl+C) may be inputted by using a keyboard) after the first query result is selected from the input method panel 32 (for example, a selected first query result in FIG. 16A is highlighted by using a dashed box). After the copying, the first query result may be pasted in a text form to an input box of an instant messaging interface, as an instant messaging message for sharing, or the first query result may be pasted in a text form to an input box of a document editing interface, as document editing content.

As shown in FIG. 16B, the input method panel 32 may include a picture copying control 327 (for example, a control referred to as “Copy as a picture” in FIG. 16B). In response to a trigger operation for the picture copying control 327, the first query result may be converted into a query result picture 1601. The query result picture 1601 may be pasted to the input box of the instant messaging interface, and is shared as an instant messaging message. In some embodiments, the query result picture may be pasted to the input box of the document editing interface, and is used as document editing content.

As shown in FIG. 16C, the input method panel 32 may include a speech copying control 328 (for example, a control referred to as “Copy as a speech” in FIG. 16C). In response to a trigger operation for the speech copying control 328, the first query result may be converted into a query result speech 1602. The query result speech 1602 may be pasted to the input box of the instant messaging interface, and is shared as an instant messaging message.

As shown in FIG. 16D, the input method panel 32 may include a link copying control 329 (for example, a control referred to as “Copy as a link” in FIG. 16D). In response to a trigger operation for the link copying control 329, the first query result may be converted into a query result link 1603. The query result link 1603 may be pasted to the input box of the instant messaging interface, and is shared as an instant messaging message. In some embodiments, the query result link may be pasted to the input box of the document editing interface, and is used as document editing content.

As shown in FIG. 16E, the input method panel 32 may include a copying control 330 (for example, a control referred to as “Copy” in FIG. 16E). In response to a trigger operation for the copying control 330, a sharing type list 331 may be displayed, and a sharing form (for example, a text, a picture, a speech, or a link) of the first query result may be selected from the sharing type list 331. For example, when the selected sharing form is the picture form, the first query result may be converted into a query result picture, and the query result picture may be pasted to the input box of the instant messaging interface, as an instant messaging message for sharing; or the query result picture may be pasted to the input box of the document editing interface, as document editing content.

Through a sharing operation for the query result, the query result can be further used in addition to being viewed, thereby improving availability of the query result, and satisfying a requirement of a content consumer for using the query result. In addition, the query result may be used in different forms (such as a text, a picture, a speech, and a link), thereby enriching use forms of the query result, and further improving the availability of the query result.

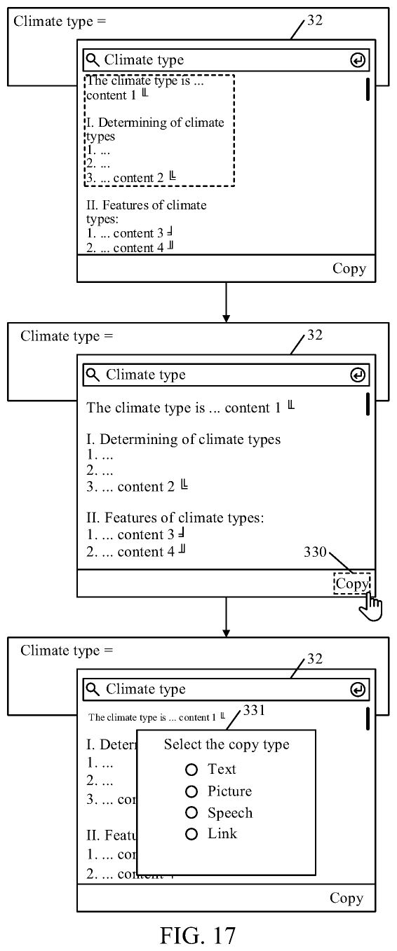

The sharing of the query result means entirely sharing the query result. One or more embodiments may further support partially sharing of the query content. Specifically, result content to be shared may be selected in the first query result, and the selected result content is shared. As shown in FIG. 17, after partial result content of the first query result is selected in the input method panel 32 (for example, the selected result content in FIG. 17 is highlighted by using a dashed box), the sharing type list 331 may be displayed in response to the trigger operation for the copying control 330 (for example, a control referred to as “Copy” in FIG. 17), and a sharing form (such as a text, a picture, a speech, and a link) of the selected result content may be selected in the sharing type list 331.

FIG. 17 illustrates a process of partially sharing the query result by using an example in which a sharing form is further selected after selecting the result content. In addition to this manner, similar to entirely sharing the query result, the selected result content may be shared in a text form by inputting a copying instruction, or the selected result content may be shared in a picture form by using a separate picture copying control, or the selected result content may be shared in a speech form by using a separate speech copying control, or the selected result content may be shared in a link form by using a separate link copying control. The content inputter may have a requirement for using only partial content in the query result. Therefore, by sharing the result content selected from the query result, the content inputter can use the query result as required, and use the query result more flexibly.

In one or more embodiments, the query result corresponding to the input content may be obtained by inputting the query sign. The query sign is inputted easily and quickly, so that the query result corresponding to the input content can be quickly obtained in the content input process by inputting the query sign. By sharing the query result, the query result may be further used in addition to being viewed, thereby improving the availability of the query result.

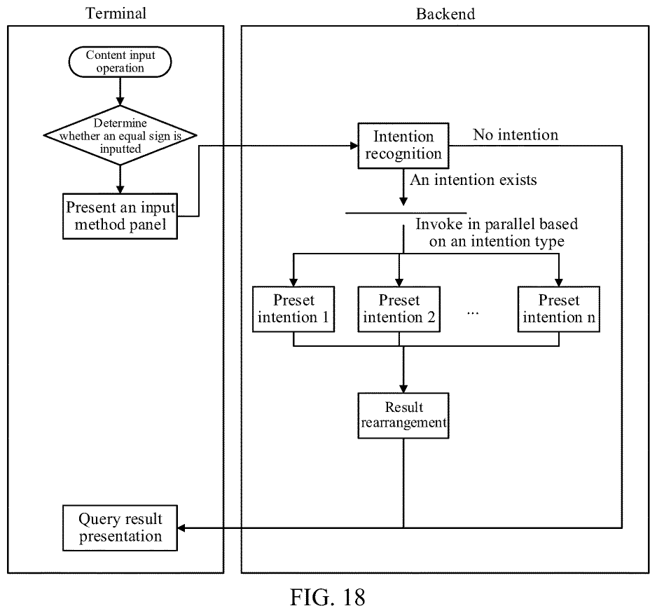

Before the content processing method provided in one or more embodiments is described in detail from a technical perspective, an interaction procedure of a terminal of the content inputter and a backend server when the content processing method is performed is first described herein. The interaction procedure of the content processing method performed by the terminal of the content inputter and the backend server is shown in FIG. 18, and may include the following operations.

(1) The terminal receives a content input operation of the content inputter. If detecting that a query sign is inputted by the content input operation, the terminal may send a query request to the backend server, and simultaneously display an input method panel (the input method panel may also be referred to as an AI panel). The query request may carry content inputted by the content input operation (input content for short below).

(2) After receiving the query request, the backend server may perform a first validity check on the query request, to determine whether the query request is a valid request. If the query request is a valid request, (3) may be performed. If the request is an invalid request, a query service may be rejected to be provided, and a query failure prompt may be outputted to the input method panel.

The first validity check herein means performing identity and permission check on the query request, and the identity and permission check means determining whether the query request is a request sent by an input method run on the terminal. If the query request is the request sent by the input method run on the terminal, it may be determined that the query request is a valid request; or if the query request is not the request sent by the input method run on the terminal, it may be determined that the query request is an invalid request.

(3) The backend server may perform a second validity check on the input content carried in the query request, to determine whether the input content is valid content. If the input content is valid content, (4) may be performed. If the input content is invalid content, the query service may be rejected to be provided, and the query failure prompt may be outputted to the input method panel.

The second validity check herein means checking whether an invalid word exists in the input content (for example, the invalid word means a sensitive word). If an invalid word exists in the input content, it may be determined that the input content is invalid content. If no invalid word exists in the input content, it may be determined that the input content is valid content. Specifically, the backend server may maintain a cache of an invalid word list (for example, the invalid word list refers to a sensitive word list), and if finding that the list expires, may pull a latest invalid word list from a content management system (CMS). The backend server may check the input content by using an Aho-Corasick (AC) algorithm, to determine whether the input content includes an invalid word. If the input content includes an invalid word, it may be determined that the input content is invalid content, the query service may be rejected to be provided, and the query failure prompt may be outputted to the input method panel. If the input content does not include an invalid word, it may be determined that the input content is valid content, and (4) may be performed.

(4) The backend server may perform intention recognition on the input content.

Specifically, the backend server may invoke an intention recognition model to perform intention recognition on the input content. If one or more matching intentions of the input content are determined in the plurality of preset intentions, (5) may be performed; or if no matching intention of the input content exists in the plurality of preset intentions, the query service may be rejected to be provided, and the query failure prompt may be outputted to the input method panel. The plurality of preset intentions are set by the input method, each preset intention corresponds to a query model, and the query model is an AI large model. The plurality of preset intentions are, for example, a preset intention 1 to a preset intention n in FIG. 18, where n is an integer greater than 1.

(5) The backend server may invoke the query model corresponding to each matching intention by using an interface corresponding to each matching intention to perform result querying on the input content, to obtain a query result of the input content under each matching intention.

(6) The backend server may sort the query result of the input content under each matching intention.

Specifically, the backend server may obtain an association between the input content and the query result under each matching intention. The backend server may further obtain completeness of the query result under each matching intention. The backend server may determine a sorting weight of the query result under each matching intention based on the association between the input content and the query result under each matching intention and completeness of the query result under each matching intention, and sort one or more query results under the one or more matching intentions based on the sorting weight of the query results under the matching intentions.

(7) The backend server may determine, based on the sorting result, a first query result corresponding to the input content, and return the first query result to the terminal. The terminal presents the first query result to the content inputter.

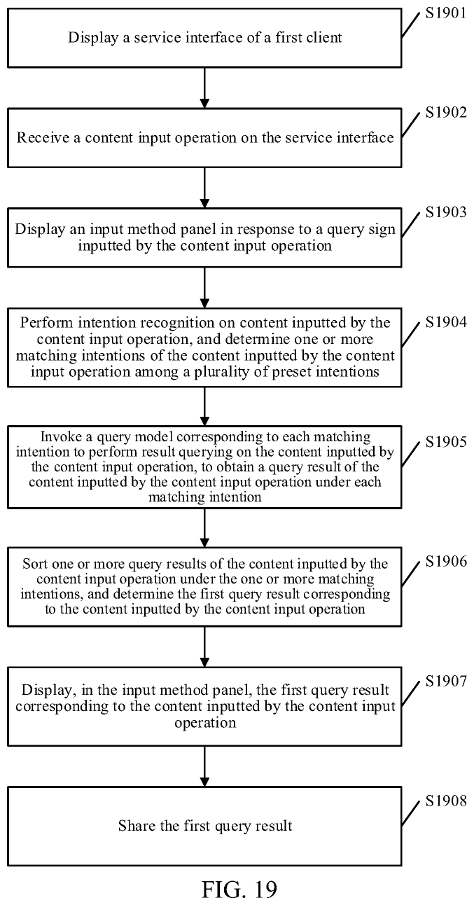

The content processing method provided in one or more embodiments is described in detail below from a technical perspective with reference to FIG. 19. The content processing method may include, but is not limited to, the following operation S1901 to operation S1908.

S1901: Display a service interface of a first client.

S1902: Receive a content input operation on the service interface.

S1903: Display an input method panel in response to a query sign inputted by the content input operation.

S1904: Perform intention recognition on content inputted by the content input operation, and determine one or more matching intentions of the content inputted by the content input operation among a plurality of preset intentions.

S1905: Invoke a query model corresponding to each matching intention to perform result querying on the content inputted by the content input operation, to obtain a query result of the content inputted by the content input operation under each matching intention.

Any one of the one or more matching intentions may be represented as a target matching intention.

When the target matching intention is an explicit intention, a process of invoking a query model corresponding to the target matching intention to perform result querying on the content inputted by the content input operation (input content for short below), to obtain a query result of the content inputted by the content input operation under the target matching intention may include: invoking the query model corresponding to the target matching intention, obtaining answer content corresponding to the input content, and determining the answer content corresponding to the input content as the query result of the input content under the target matching intention.

When the target matching intention is a general intention, a process of invoking the query model corresponding to the target matching intention to perform result querying on the content inputted by the content input operation (input content for short below), to obtain a query result of the content inputted by the content input operation under the target matching intention may include the following operations.

(1) Invoke the query model corresponding to the target matching intention to generate the answer content corresponding to the content inputted by the content input operation.

Specifically, retrieval processing may be performed on the content inputted by the content input operation, to obtain retrieved content; and if a book relevant to the content inputted by the content input operation exists in the retrieved content, the query model corresponding to the target matching intention may be invoked to generate the answer content based on abstract content of the book; or if no book relevant to the content inputted by the content input operation exists in the retrieved content and a quantity of pieces of the retrieved content is less than or equal to a first quantity threshold, the query model corresponding to the target matching intention may be invoked to generate the answer content based on the content inputted by the content input operation; or if the quantity of pieces of the retrieved content is greater than the first quantity threshold, the query model corresponding to the target matching intention may be invoked to generate the answer content based on the retrieved content.

The retrieved content may be retrieved from a book. That a book is relevant to the input content means that a title of the book is similar to the input content.

(2) Invoke the query model corresponding to the target matching intention to retrieve the reference content of the answer content.

Specifically, if the answer content is generated based on the retrieved content corresponding to the content inputted by the content input operation, retrieved content with a similarity to the answer content greater than a first similarity threshold in the retrieved content may be determined as the reference content of the answer content, and a reference relationship may be established; or if the answer content is not generated based on the retrieved content corresponding to the content inputted by the content input operation, the query model corresponding to the target matching intention may be invoked to retrieve, based on the answer content, books relevant to the answer content, a book with a similarity to the answer content greater than a second similarity threshold in the retrieved books may be determined as the reference content of the answer content, and a reference relationship may be established.

(3) Invoke the query model corresponding to the target matching intention to generate query content semantically relevant to the content inputted by the content input operation.

Specifically, if the answer content is generated based on the retrieved content corresponding to the content inputted by the content input operation, the query model corresponding to the target matching intention may be invoked to generate, based on the retrieved content and the content inputted by the content input operation, the query content semantically relevant to the content inputted by the content input operation; and if a book relevant to the content inputted by the content input operation exists in the retrieved content, query content associated with the book may be used as the query content semantically relevant to the content inputted by the content input operation.

(4) Determine the answer content corresponding to the content inputted by the content input operation, reference information of the reference content of the answer content, and the query content semantically relevant to the content inputted by the content input operation as the query result of the content inputted by the content input operation under the target matching intention.

S1906: Sort one or more query results of the content inputted by the content input operation under the one or more matching intentions, and determine the first query result corresponding to the content inputted by the content input operation.

Specifically, the sorting process may include: an association between the input content and the query result under each matching intention may be obtained, where the association herein refers to a semantic association degree between the input content and the query result under each matching intention; completeness of the query result of each matching intention may be further obtained, where the completeness may be determined based on a repetition score of the query result (the repetition score is a ratio of a quantity of pieces of repeated information in the query result to a total quantity of words in the query result), a context consistency score of the query result (the context consistency score is obtained by training a dedicated model to evaluate the input content), and a human preference score (the human preference score is obtained by training a model simulating human preference to evaluate the input content); and a sorting weight of the query result under each matching intention may be determined based on the association between the input content and the query result under each matching intention and the completeness of the query result under each matching intention, and one or more query results under the one or more matching intentions are sorted based on sorting weight of the query result under each matching intentions. A larger sorting weight of a query result under any matching intention indicates higher relevance between the query result under the matching intention and the input content, and indicates a higher possibility that the query result under the matching intention is used as a final query result of the input content.

After the sorting, a query result having the largest sorting weight among the query results of the matching intentions may be used as the first query result corresponding to the input content. When the one or more query results under the one or more matching intentions are sorted in descending order of one or more sorting weights, a query result arranged first is the query result having the largest sorting weight. When the one or more query results under the one or more matching intentions are sorted in ascending order of one or more sorting weights, a query result arranged last is the query result having the largest sorting weight.

S1907: Display, in the input method panel, the first query result corresponding to the content inputted by the content input operation.

S1908: Share the first query result.

In one or more embodiments, the query model corresponding to each preset intention may be an AI large model. A generation capability of the AI large model is combined with the content input process, so that the AI large model may be used to quickly generate the query result corresponding to the input content in the content generation process, thereby improving query efficiency in the content input process by using the AI large model.

FIG. 19 illustrates generation logic of the query result in detail. In a process of generating the query result by using a large model, a procedure of the large model is usually long. If the large model generates all the query result and then returns the query result to the terminal, the content inputter waits for excessively long time for the query result. To avoid the content inputter waiting excessively long for the query result, one query request of the content inputter may be split into several requests by the terminal. Each time the terminal initiates a request, the backend server returns a partial query result. During specific implementation, the terminal initiates the query request, and the backend server may generate a session identifier (sessionid) for the query request of the content inputter, which is configured for representing a complete request. For the first request in the query request initiated by the terminal, the backend server may generate the session identifier (sessionid) for the query request and return the session identifier to the terminal. For a subsequent request in the query request initiated by the terminal, the session identifier (sessionid) may be carried.

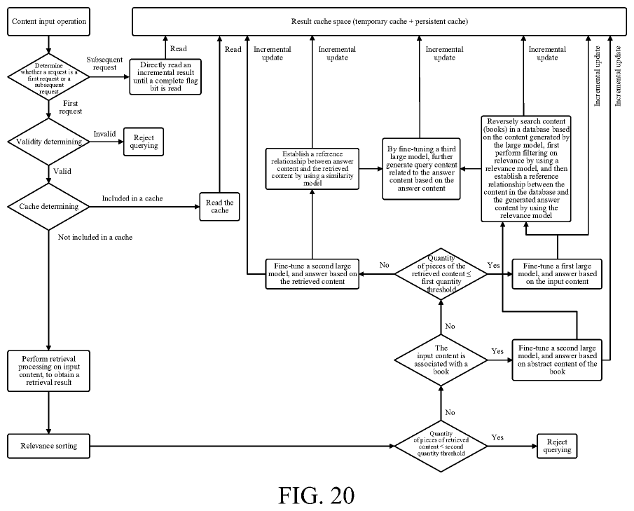

The backend server may determine, based on the session identifier (sessionid), whether the request is the first request or a subsequent request. Because a procedure of a large model is usually long, the entire procedure is designed as an incremental update procedure. The first request is mainly configured for retrieving content, designing a start flag bit, and send a response packet (that is, return a response packet) to the terminal. The terminal may determine, based on a complete flag bit of a returned response packet, whether the procedure is completed or a request continues. A specific procedure is as shown in FIG. 20.

### 1. For the First Request:

### (1) Validity Determining:

If the request is the first request, validity of the first request may be determined. The validity determining may include frequency determining, blacklist determining, and anti-spam determining. The frequency determining means determining whether a quantity of query times of the content inputter within a statistical time period exceeds a query threshold. The blacklist determining means determining whether the content inputter is a blacklist object. The anti-spam determining means checking whether an invalid word exists in the input content. A process of the validity determining may include: determining whether the quantity of query times of the content inputter within the statistical period exceeds the query threshold; if the quantity of query times exceeds the query threshold, the first request is an invalid request, and the first request may be rejected to be processed; or if the quantity of query times does not exceed the query threshold, whether the content inputter is a blacklist object may be determined; if the content inputter is a blacklist object, the first request is an invalid request, and the first request may be rejected to be processed; or if the content inputter is not a blacklist object, anti-spam determining may be performed on the input content, where the anti-spam determining means checking whether an invalid word exists in the input content; and if no invalid word exists, it may be determined that the first request is a valid request, and (2) may be performed; or if an invalid word exists, the first request may be rejected to be processed.

### (2) Cache Determining:

A cache determining process may include: querying the input content in a personal cache table of the content inputter. The personal cache table of the content inputter may be configured for caching content that has been queried by the content inputter and identifier data of a query result corresponding to the queried content. The objective of the query herein is to query whether the input content has been queried by the content inputter. If the input content has been queried by the content inputter, identifier data of a first query result corresponding to the input content may be obtained from the personal cache table, and the first query result corresponding to the input content may be obtained from a result cache space by using the identifier data.

If the input content has not been queried by the content inputter, the input content may be queried in the result cache space. The result cache space may be configured for caching queried content and a query result corresponding to the queried content. The objective of the query herein is to query whether the input content has been queried by another inputter. If the input content has been queried by another inputter, a first query result corresponding to the input content may be read from the result cache space, and returned to the content inputter. In addition, the identifier data of the first query result corresponding to the input content may be cached into the personal cache table of the content inputter. In this way, it can be ensured that the same query result is obtained when the content inputter queries subsequent same input content. If the input content has not been queried by another inputter, (3) may be performed.

The anti-spam determining needs to be performed on the query result again, and a query result (that is, the query result does not include an invalid word) passing the anti-spam determining can be returned to the content inputter. In this way, it can be ensured that the query result outputted to the content inputter is valid content.

### (3) Perform Retrieval Processing on the Input Content, to Obtain Retrieved Content:

For input content (query) that does not have a cached result, content relevant to the input content (query) needs to be retrieved by using a retrieval service (emb service) as the retrieved content. The retrieved content may be, for example, from a book or a core opinion.

### (4) Relevance Sorting:

The input content (query) and the retrieved content are sorted by using a relevance model, retrieved content with relevance lower than a threshold is filtered out according to a specific relevance threshold, and the retrieved content is sorted in descending order of relevance scores. Before the large model formally generates an answer, a flag bit is generated, a standard generation procedure starts, and the flag bit is incrementally written to storage. In this case, a response packet is requested to be generated for the first time, and the following procedures are performed asynchronously.

### (5) the Large Model Generates the Answer Content:

Specifically, if a quantity of pieces of retrieved content subjected to relevance filtering is less than or equal to a second quantity threshold (the second quantity threshold may be set according to an empirical value, and may be, for example, 1), the query may be rejected. If the quantity of pieces of the retrieved content is greater than the second quantity threshold and less than or equal to a first quantity threshold (the first quantity threshold may be set according to an empirical value, and may be, for example, 5), the large model may directly answer based on the input content (query) without relying on the retrieved content, to obtain the answer content. The large model herein is a particular fine-tuned model, which is referred to as model1 (a first large model) herein.

If the quantity of pieces of the retrieved content subjected to relevance filtering is sufficient (for example, the quantity of pieces of the retrieved content is greater than the first quantity threshold), retained retrieved content (that is, the retrieved content subjected to relevance filtering) may be inputted to the large model, so that the large model answers based on specified retrieved content, to obtain the answer content. The large model herein is a particular fine-tuned model, which is referred to as model2 (a second large model) herein.

If the input content (query) is directly associated with a book, abstract content of the book may be used as the input content of the large model, and the large model answers based on the abstract content, to obtain the answer content. The large model herein is model2 (the second large model).

The generated answer content may be incrementally written to the storage.

### (6) the Large Model Generates Relevant Query Content:

Specifically, based on answer content generated by the large model, each sentence can be combined with the input query to generate semantically relevant to the query content by using a fine-tuned large model model3 (the third large model)

If the input content (query) is associated with the book, or the answer content is generated based on the abstract content of the book, a book-relevant question that is offline generated is directly used as the query content semantically relevant to the input content.

The generated query content may be incrementally written to the storage.

### (7) Generate Reference:

Specifically, if the retrieved content exists, similarity association may be performed between the answer content and the retrieved content based on the generated answer content and the retrieved content by using a similarity model. For a case in which a similarity reaches a specific threshold, a reference relationship between the answer content and the retrieved content may be established.

If no retrieved content exists, the book may be retrieved reversely based on the generated answer content, and similarity association is then performed between the answer content and the book by using the similarity model. For a case in which a similarity reaches a specific threshold, a reference relationship between the answer content and the book may be established.

The generated reference relationship may be incrementally written to the storage.

### (8) Update a Cache:

The generated data is written into the cache, and can be directly reused for a subsequent request.

### 2. For a Non-First Request:

Based on a unique session identifier returned in the first request, corresponding storage is read directly, and the content in the storage is directly returned to a content user after passing anti-spam. If the content triggers the anti-spam, the entire procedure ends immediately; otherwise, the procedure ends when the complete flag bit is read.

In one or more embodiments, a generation capability of the AI large model is combined with the content input process, so that the AI large model may be used to quickly generate the query result corresponding to the input content in the content generation process, thereby improving query efficiency in the content input process by using the AI large model.

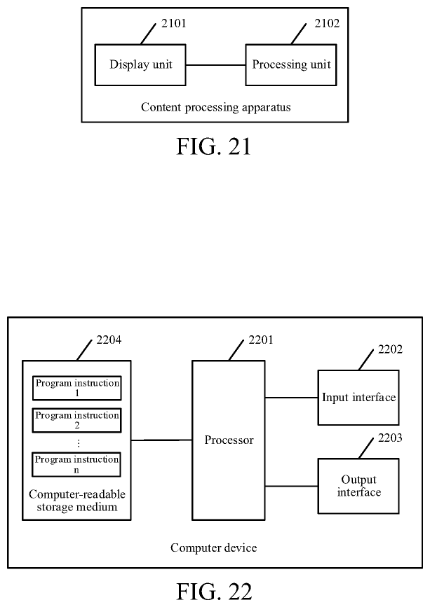

FIG. 21 is a schematic structural diagram of a content processing apparatus according to one or more embodiments. The content processing apparatus may be disposed in a computer device provided in one or more embodiments. The computer device may be a terminal of a content inputter, or may be a content processing system including a terminal of a content inputter and a backend server. The apparatus shown in FIG. 21 may be a computer program run in the computer device. The apparatus may be configured to perform some or all of the operations in the method embodiments shown in FIG. 2, FIG. 13, or FIG. 19. Refer to FIG. 21, the content processing apparatus may include the following units:
a display unit 2101, configured to display a service interface of a first client,
the display unit 2101 being further configured to receive a content input operation on the service interface; and
the display unit 2101 being further configured to display an input method panel in response to a query sign inputted by the content input operation, and display, in the input method panel, a first query result corresponding to content inputted by the content input operation.

In some embodiments, the display unit 2101 is configured to specifically perform the following operation when being configured to display the input method panel in response to the query sign inputted by the content input operation:
displaying the input method panel in response to the query sign inputted, after target content is inputted, by the content input operation.

In some embodiments, the query sign is located at any position of the target content; and the display unit 2101 is specifically configured to perform the following operation when being configured to display, in the input method panel, the first query result corresponding to the content inputted by the content input operation:
displaying, in the input method panel, a first query result corresponding to the target content.

In some embodiments, the display unit 2101 is specifically configured to perform the following operation when being configured to display, in the input method panel, the first query result corresponding to the content inputted by the content input operation:
displaying, in the input method panel, a first query result corresponding to first content when the query sign is located in the target content, the first content being content located before the query sign in the target content; or
displaying, in the input method panel, a first query result corresponding to the target content when the query sign is located at a beginning or a tail of the target content.

In some embodiments, the display unit 2101 is further configured to perform the following operation:
triggering, in response to the query sign inputted by the content input operation if a service type of the first client is a first service type, the displaying an input method panel, the first service type being a service type in which the query sign is inputted at a low frequency; or
skipping, if the service type of the first client is a second service type, the displaying an input method panel, the second service type being a service type in which the query sign is inputted at a high frequency.
In some embodiments, the first query result includes at least one of the following:
answer content corresponding to the content inputted by the content input operation;
reference information of the answer content, the reference information of the answer content being introduction information of reference content referenced by the answer content; or
query content semantically relevant to the content inputted by the content input operation.

In some embodiments, a plurality of preset intentions are set in the input method to which the input method panel belongs, the plurality of preset intentions including an explicit intention and a general intention, the explicit intention being an intention for obtaining a query result of a specific type, and the general intention being an intention for obtaining a general query result;
when a query intention of the content inputted by the content input operation is the explicit intention, the first query result includes the answer content corresponding to the content inputted by the content input operation; or
when a query intention of the content inputted by the content input operation is the general intention, the first query result includes the answer content corresponding to the content inputted by the content input operation, the reference information of the answer content, and the query content semantically relevant to the content inputted by the content input operation.

In some embodiments, the display unit 2101 is further configured to perform the following operation:
displaying an original text of the reference content in response to a trigger operation for the reference information.

In some embodiments, a source of the reference content is a second client; and the display unit 2101 is specifically configured to perform the following operation when being configured to display the original text of the reference content in response to the trigger operation for the reference information:
displaying the original text of the reference content in the second client in response to the trigger operation for the reference information.

In some embodiments, the answer content includes one or more pieces of subcontent, a reference marker is added to each piece of target subcontent including reference content in the answer content, the reference information includes reference information of each piece of target subcontent, and the reference information of each piece of target subcontent is introduction information of reference content referenced by the target subcontent, a reference marker of the reference information of each piece of target subcontent corresponding to the reference marker added to the target subcontent; and
the display unit 2101 is specifically configured to perform the following operation when being configured to display the original text of the reference content in response to the trigger operation for the reference information:
displaying, in response to a trigger operation for reference information of any piece of target subcontent, an original text of reference content referenced by the any piece of target subcontent.

In some embodiments, the display unit 2101 is further configured to perform the following operation:
displaying, in the input method panel in response to a query operation for the query content, a second query result corresponding to the query content.

In some embodiments, a plurality of preset intentions are set in the input method to which the input method panel belongs; and the display unit 2101 is specifically configured to perform the following operation when being configured to display, in the input method panel, the first query result corresponding to the content inputted by the content input operation:
displaying, in the input method panel, a query result corresponding to the content inputted by the content input operation under a first preset intention,
the first preset intention being a preset intention in a highest association with the query intention of the content inputted by the content input operation among the plurality of preset intentions.

In some embodiments, the display unit 2101 is further configured to perform the following operation:
sharing the first query result.

In some embodiments, the display unit 2101 is configured to perform any one of the following when being configured to share the first query result:
sharing the first query result in a text form;
sharing the first query result in a picture form;
sharing the first query result in a speech form; or
sharing the first query result in a link form.

In some embodiments, the display unit 2101 is further configured to perform the following operation:
selecting, in the first query result, result content to be shared; and
the display unit 2101 is configured to perform the following operation when being configured to share the first query result:
sharing the selected result content.

In some embodiments, the display unit 2101 is further configured to perform the following operation:
displaying the input method panel in response to a trigger operation for a query control; or displaying the input method panel in response to an inputted query gesture.

In some embodiments, the content processing apparatus further includes a processing unit 2102, configured to perform the following operations:
performing intention recognition on the content inputted by the content input operation, and determining one or more matching intentions of the content inputted by the content input operation among the plurality of preset intentions, each preset intention corresponding to a query model thereof;
invoking a query model corresponding to each matching intention to perform result querying on the content inputted by the content input operation, to obtain a query result of the content inputted by the content input operation under each matching intention; and
sorting one or more query results of the content inputted by the content input operation under the one or more matching intentions, and determining the first query result corresponding to the content inputted by the content input operation.

In some embodiments, any one of the one or more matching intentions is represented as a target matching intention; and the processing unit 2102 is specifically configured to perform the following operations when being configured to invoke the query model corresponding to the target matching intention to perform result querying on the content inputted by the content input operation, to obtain the query result of the content inputted by the content input operation under the target matching intention:
invoking the query model corresponding to the target matching intention to generate the answer content corresponding to the content inputted by the content input operation;
invoking the query model corresponding to the target matching intention to retrieve the reference content of the answer content;
invoking the query model corresponding to the target matching intention to generate the query content semantically relevant to the content inputted by the content input operation; and
determining the answer content corresponding to the content inputted by the content input operation, the reference information of the reference content of the answer content, and the query content semantically relevant to the content inputted by the content input operation as the query result of the content inputted by the content input operation under the target matching intention.

In some embodiments, the processing unit 2102 is specifically configured to perform the following operations when being configured to invoke the query model corresponding to the target matching intention to generate the answer content corresponding to the content inputted by the content input operation:
performing retrieval processing on the content inputted by the content input operation, to obtain retrieved content; and
invoking, if a book relevant to the content inputted by the content input operation exists in the retrieved content, the query model corresponding to the target matching intention to generate the answer content based on abstract content of the book; or
invoking, if no book relevant to the content inputted by the content input operation exists in the retrieved content and a quantity of pieces of the retrieved content is less than or equal to a first quantity threshold, the query model corresponding to the target matching intention to generate the answer content based on the content inputted by the content input operation; or
invoking, if a quantity of pieces of the retrieved content is greater than a first quantity threshold, the query model corresponding to the target matching intention to generate the answer content based on the retrieved content.

In some embodiments, the processing unit 2102 is specifically configured to perform the following operation when being configured to invoke the query model corresponding to the target matching intention to retrieve the reference content of the answer content:
determining, if the answer content is generated based on the retrieved content corresponding to the content inputted by the content input operation, retrieved content with a similarity to the answer content greater than a first similarity threshold in the retrieved content as the reference content of the answer content; or
invoking, if the answer content is not generated based on the retrieved content corresponding to the content inputted by the content input operation, the query model corresponding to the target matching intention to retrieve, based on the answer content, books relevant to the answer content, and determining a book with a similarity to the answer content greater than a second similarity threshold in the retrieved books as the reference content of the answer content.

In some embodiments, the processing unit 2102 is specifically configured to perform the following operations when being configured to invoke the query model corresponding to the target matching intention to generate the query content semantically relevant to the content inputted by the content input operation:
invoking, if the answer content is generated based on the retrieved content corresponding to the content inputted by the content input operation, the query model corresponding to the target matching intention to generate, based on the retrieved content and the content inputted by the content input operation, the query content semantically relevant to the content inputted by the content input operation; and
determining, if a book relevant to the content inputted by the content input operation exists in the retrieved content, query content associated with the book as the query content semantically relevant to the content inputted by the content input operation.

According to one or more embodiments, units of the content processing apparatus shown in FIG. 22 may be separately or wholly combined into one or several other units, or one (or more) of the units may further be divided into a plurality of units of smaller functions. In this way, the same operations can be implemented, and implementation of the technical effects of one or more embodiments is not affected. The foregoing units are divided based on logical functions. In some embodiments, functions of one unit may also be implemented by a plurality of units, or functions of a plurality of units may be implemented by one unit. In some embodiments, the content processing apparatus may include another unit. In some embodiments, these functions may be implemented with assistance of another unit, and may be implemented by a plurality of units in collaboration.

According to one or more embodiments, a computer program that can perform the operations involved in some or all of the method shown in FIG. 2, FIG. 13, or FIG. 19 may be run on a general-purpose computing device such as a computer that includes processing components and storage components such as a central processing unit (CPU), a random access memory (RAM), and a read-only memory (ROM), to construct the content processing apparatus shown in FIG. 21 and implement the content processing method in some embodiments. The computer program may be stored in, for example, a computer-readable storage medium, and is installed in the computing device through the computer-readable storage medium, and is run in the computing device.

In some embodiments, a content input operation on a service interface may be received, in response to a query sign inputted by the content input operation, an input method panel may be displayed, and a first query result corresponding to content inputted by the content input operation may be displayed in the input method panel. In other words, in some embodiments, a query result corresponding to input content may be obtained by inputting the query sign. The query sign is inputted easily and quickly. Therefore, in some embodiments, the query result corresponding to the input content can be quickly obtained in a content input process by inputting the query sign.

FIG. 22 is a schematic structural diagram of a computer device according to one or more embodiments. The computer device shown in FIG. 22 includes at least a processor 2201, an input interface 2202, an output interface 2203, and a computer-readable storage medium 2204. The processor 2201, the input interface 2202, the output interface 2203, and the computer-readable storage medium 2204 may be connected through a bus or in another manner.

The computer-readable storage medium 2204 may be stored in a memory of the computer device. The computer-readable storage medium 2204 is configured to store a computer program. The computer program includes a computer instruction. The processor 2201 is configured to execute the computer program stored in the computer-readable storage medium 2204. The processor 2201 (or referred to as a central processing unit (CPU)) is a computing core and a control core of the computer device, which is adapted to implement the computer program, and specifically adapted to load and execute the computer program to implement corresponding method processes or corresponding functions.

One or more embodiments further provides a computer-readable storage medium (memory). The computer-readable storage medium is a memory device in a computer device, and is configured to store a program and data. The computer-readable storage medium herein may include an internal storage medium of the computer device, and certainly may also include an expanded storage medium supported by the computer device. The computer-readable storage medium provides storage space, and the storage space stores an operating system of the computer device. In addition, the storage space further stores a computer program adapted to be loaded and executed by a processor. The computer-readable storage medium herein may be a high-speed RAM, or a non-volatile memory, for example, at least one disk memory. In some embodiments, the computer-readable storage medium may be at least one computer-readable storage medium away from the processor.

The computer device may be a terminal of a content inputter, or may be a content processing system including a terminal of a content inputter and a backend server. During specific implementation, the processor 2201 may load and execute a computer program stored in the computer-readable storage medium 2204, to implement corresponding operations of the method shown in FIG. 2, FIG. 13, or FIG. 19.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A content processing method, performed by a computer device, comprising:
displaying a service interface of a first client;
receiving a content input operation on the service interface;
displaying an input method panel based on a query sign input by the content input operation; and
displaying, in the input method panel, a first query result corresponding to content input by the content input operation.

2. The content processing method according to claim 1, wherein displaying the input method panel based on the query sign input by the content input operation comprises:
displaying the input method panel based on the query sign input, after target content is input, by the content input operation.

3. The content processing method according to claim 2, wherein the query sign is located at any position of the target content; and the displaying, in the input method panel, the first query result corresponding to content input by the content input operation comprises:
displaying, in the input method panel, a first query result corresponding to the target content.

4. The content processing method according to claim 2, wherein the displaying, in the input method panel, the first query result corresponding to content input by the content input operation comprises:
displaying, in the input method panel, a query result corresponding to first content when the query sign is located in the target content, the first content being content located before the query sign in the target content; or
displaying, in the input method panel, a query result corresponding to the target content when the query sign is located at a beginning or a tail of the target content.

5. The content processing method according to claim 1, further comprising:
triggering, based on a service type of the first client being a first service type, the displaying the input method panel, the first service type being a service type in which the query sign is input at a low frequency; or
skipping, based on the service type of the first client being a second service type, the displaying the input method panel, the second service type being a service type in which the query sign is input at a high frequency.

6. The content processing method according to claim 1, wherein the first query result comprises at least one of:
answer content corresponding to the content input by the content input operation;
reference information of the answer content, the reference information of the answer content being introduction information of reference content referenced by the answer content; or
query content semantically relevant to the content input by the content input operation.

7. The content processing method according to claim 6, wherein a plurality of preset intentions are set in an input method to which the input method panel belongs, the plurality of preset intentions comprising an explicit intention and a general intention, the explicit intention being an intention for obtaining a specific query result of a specific type, and the general intention being an intention for obtaining a general query result;
based on a query intention of the content input by the content input operation being the explicit intention, the first query result comprises the answer content corresponding to the content input by the content input operation; or
based on a query intention of the content input by the content input operation being the general intention, the first query result comprises the answer content corresponding to the content input by the content input operation, the reference information of the answer content, and the query content semantically relevant to the content input by the content input operation.

8. The content processing method according to claim 6, further comprising:
displaying an original text of the reference content based on a trigger operation for the reference information.

9. The content processing method according to claim 8, wherein a source of the reference content is a second client; and the displaying the original text of the reference content based on the trigger operation for the reference information comprises:
displaying the original text of the reference content in the second client based on the trigger operation for the reference information.

10. The content processing method according to claim 8, wherein the answer content comprises one or more pieces of target subcontent, a reference marker is added to each piece of target subcontent comprising reference content in the answer content, the reference information comprises reference information of each piece of target subcontent, and the reference information of each piece of target subcontent is introduction information of reference content referenced by the target subcontent, a reference marker of the reference information of each piece of target subcontent corresponding to the reference marker added to the target subcontent; and
the displaying the original text of the reference content based on the trigger operation for the reference information comprises:
displaying, based on a trigger operation for reference information of any piece of target subcontent, an original text of reference content referenced by the any piece of target subcontent.

11. The content processing method according to claim 6, further comprising:
displaying, in the input method panel based on a query operation for the query content, a second query result corresponding to the query content.

12. The content processing method according to claim 7, wherein the plurality of preset intentions are set in the input method to which the input method panel belongs; and the displaying, in the input method panel, the first query result corresponding to content input by the content input operation comprises:
displaying, in the input method panel, a query result corresponding to the content input by the content input operation under a first preset intention,
the first preset intention being a preset intention in a highest association with the query intention of the content input by the content input operation among the plurality of preset intentions.

13. The content processing method according to claim 1, further comprising:
sharing the first query result.

14. The content processing method according to claim 13, wherein the sharing the first query result comprises at least one of:
sharing the first query result in a text form;
sharing the first query result in a picture form;
sharing the first query result in a speech form; or
sharing the first query result in a link form.

15. The content processing method according to claim 13, further comprising:
selecting, in the first query result, result content to be shared; and
the sharing the first query result comprises:
sharing the selected result content.

16. The content processing method according to claim 1, further comprising at least one of:
displaying the input method panel based on a trigger operation for a query control; or
displaying the input method panel based on an input query gesture.

17. The content processing method according to claim 6, further comprising:
performing intention recognition on the content input by the content input operation, and determining one or more matching intentions of the content input by the content input operation among the plurality of preset intentions, each preset intention corresponding to a query model thereof;
invoking a query model corresponding to each matching intention to perform result querying on the content input by the content input operation, to obtain a query result of the content input by the content input operation under each matching intention; and
sorting one or more query results of the content input by the content input operation under the one or more matching intentions, and determining the first query result corresponding to the content input by the content input operation.

18. The content processing method according to claim 17, wherein any one of the one or more matching intentions is represented as a target matching intention; and the invoking the query model comprises:
invoking the query model corresponding to the target matching intention to generate the answer content corresponding to the content input by the content input operation;
invoking the query model corresponding to the target matching intention to retrieve the reference content of the answer content;
invoking the query model corresponding to the target matching intention to generate the query content semantically relevant to the content input by the content input operation; and
determining the answer content corresponding to the content input by the content input operation, the reference information of the reference content of the answer content, and the query content semantically relevant to the content input by the content input operation as the query result of the content input by the content input operation under the target matching intention.

19. A content processing apparatus, comprising:
at least one memory configured to store program code; and
at least one processor configured to read the program code and operate as instructed by the program code, the program code comprising:
display code configured to cause at least one of the at least one processor to:
display a service interface of a first client,
receive a content input operation on the service interface;
display an input method panel based on a query sign input by the content input operation; and
display, in the input method panel, a first query result corresponding to content input by the content input operation.

20. A non-transitory computer-readable storage medium, storing computer code which, when executed by at least one processor, causes the at least one processor to at least:
display a service interface of a first client,
receive a content input operation on the service interface;
display an input method panel based on a query sign input by the content input operation; and
display, in the input method panel, a first query result corresponding to content input by the content input operation.
